(19) United States
(12) Patent Application Publication
(10) Pub. No.: US 2010/0255282 A1
(43) Pub. Date: Oct. 7, 2010

(54) HIGH TEMPERATURE RESISTANT INSULATING COMPOSITION, INSULATING WIRE AND MAGNETIC ELEMENT

(75) Inventors: Shou-Yu Hong, Pudong (CN); Wei Yang, Pudong (CN); Jian-Hong Zeng, Pudong (CN); Jian-Ping Ying, Pudong (CN)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/754,021

(22) Filed: Apr. 5, 2010

(30) Foreign Application Priority Data
Apr. 7, 2009 (TW) 098111575

(51) Int. Cl. H01F 27/36; H01F 7/00; H01F 1/01; C08L 83/00; C08L 79/08; C08K 9/00; C08K 3/40

(52) U.S. Cl. 428/222; 428/375; 524/588; 524/606; 523/217

(57) ABSTRACT

A high temperature resistant insulating composition includes an organic polymer and an inorganic binder. The inorganic binder is ranged between 10% and 90% by weight of the high temperature resistant insulating composition. The high temperature resistant insulating composition still possesses strength and insulating property after a high temperature treatment.

### FIELD OF THE INVENTION

The present invention relates to an insulating composition, and more particularly to a high temperature resistant insulating composition. The present invention also relates to an insulating wire containing the high temperature resistant insulating composition, and a magnetic element having the insulating wire.

### BACKGROUND OF THE INVENTION

Nowadays, magnetic elements such as inductors and transformers are widely used in power supply apparatuses or many electronic devices to generate induced magnetic fluxes. Generally, a magnetic element includes a coil and a magnetic core. The magnetic core is made of soft magnetic material for example. A common soft magnetic material for producing the magnetic core of the magnetic element is Fe magnetic powder. A process for fabricating a magnetic element (e.g. an inductor) by using Fe magnetic powder will be illustrated in more details as follows. First of all, a conductive wire is provided. Then, the conductive wire is coated with an insulating layer and shaped as a coil. The insulating layer is made of for example polyimide, polyester, polyesterimide or polyamideimide. Such insulating layer could usually withstand a temperature lower than 240° C. The coil is then buried in Fe magnetic powder. The coil and the Fe magnetic powder are compacted in a mold, thereby producing a magnetic element.

Since no high-temperature treatment (e.g. above 400° C.) is used after the magnetic element is formed by compacting and the conductive wire is coated with the ordinary insulating material to form the coil, the convention process for fabricating the magnetic element is very simple and cost-effective. The magnetic element produced by the convention process, however, has larger magnetic loss and poor electromagnetic properties. Therefore, the magnetic element fabricated by this convention process is usually used in the low-end electronic products.

For improving the electromagnetic properties of the magnetic element, another process for fabricating the magnetic element uses other magnetic powder core, take Fe-based magnetic powder core for example, such as FeAlSi magnetic powder core, FeNi magnetic powder core, FeNiMo magnetic powder core, FeSi magnetic powder core, FeSiCr magnetic powder core, FeNiZn magnetic powder core or FeMnZn magnetic powder core. The process for fabricating the magnetic element by using the Fe-based magnetic powder core usually needs a high temperature annealing/sintering procedure at a temperature usually above 400° C. The coil coated with the ordinary insulating material fails to withstand such high-temperature treatment.

A process for fabricating the magnetic element by using the Fe-based magnetic powder core will be illustrated in more details as follows. First of all, Fe-based magnetic powder (e.g. FeAlSi magnetic powder) is compacted under a compacting pressure in a mold. Next, the compacted Fe-based magnetic powder core is subject to an annealing procedure at for example 650° C., thereby producing a magnetic core. Afterwards, the coil coated with the ordinary insulating material is wound around the magnetic core, thereby producing the magnetic element. Although the magnetic element fabricated by this process has good electromagnetic properties, this fabricating process is more complicated, has low throughput, and is not excellently suitable for mass production. In addition, the magnetic element has less space utilization and thus fails to be applied in high power density electronic product.

### SUMMARY OF THE INVENTION

An object of the present invention provides a high temperature resistant insulating composition including an organic polymer and an inorganic binder. The high temperature resistant insulating composition has flexibility and toughness at a low temperature between −60° C. to about 200° C., for example the room temperature. After a high temperature treatment above 400° C. is performed, the residual of the high temperature resistant insulating composition still possesses high strength and insulating property.

Another object of the present invention provides an insulating wire including a conductive wire and an insulating coating layer sheathing around said conductive wire, in which the insulating coating layer is made of the high temperature resistant insulating composition of the present invention.

A further object of the present invention provides a magnetic element including a magnetic body and a coil wound by the insulating wire. The coil could be directly buried within the magnetic powder core that withstands high temperature annealing/sintering procedure, the process for fabricating magnetic elements according to the present invention has increased throughput, and is suitable for mass production.

In accordance with an aspect of the present invention, there is provided a high temperature resistant insulating composition. The high temperature resistant insulating composition includes an organic polymer and an inorganic binder. The inorganic binder is ranged between 10% and 90% by weight of the high temperature resistant insulating composition. The high temperature resistant insulating composition still possesses strength and insulating property after a high temperature treatment.

In accordance with another aspect of the present invention, there is provided an insulating wire. The insulating wire includes a conductive wire and an insulating coating layer. The insulating coating layer is sheathed around the conductive wire and made of a high temperature resistant insulating composition. The high temperature resistant insulating composition includes an organic polymer and an inorganic binder ranged between 10% and 90% by weight of the high temperature resistant insulating composition. The high temperature resistant insulating composition after a high temperature treatment still possesses strength and insulating property.

In accordance with a further aspect of the present invention, there is provided a magnetic element. The magnetic element includes a magnetic body and an insulating wire. The insulating wire is wound into a coil and at least partially accommodated within the magnetic body. The insulating wire includes a conductive wire and an insulating coating layer. The insulating coating layer is sheathed around the conductive wire and made of a high temperature resistant insulating composition. The high temperature resistant insulating composition includes an organic polymer and an inorganic binder ranged between 10% and 90% by weight of the high temperature resistant insulating composition. The high temperature resistant insulating composition after a high temperature treatment still possesses strength and insulating property.

The above contents of the present invention will become more readily apparent to those ordinarily skilled in the art after reviewing the following detailed description and accompanying drawings, in which:

### BRIEF DESCRIPTION OF THE DRAWINGS

FIG. 1A schematically illustrates the mixture of the inorganic binder and the organic polymer of the high temperature resistant insulating composition before the high temperature treatment;

FIG. 1B schematically illustrates the mixture of the inorganic binder and the residual of the organic polymer after the high temperature treatment and a cooling procedure;

FIG. 2A is a schematic perspective view illustrating a coil made with an insulating wire coated with the high temperature resistant insulating composition of the present invention;

FIG. 2B is a schematic cross-sectional view of the insulating wire shown in FIG. 2A;

FIG. 3 schematically illustrates a flowchart of a process for fabricating an insulating wire according to the present invention;

FIGS. 4A, 4B and 4C are schematic views illustrating the steps of fabricating a magnetic element according to the present invention; and

FIG. 5 schematically illustrates a flowchart of a process for fabricating a magnetic element according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention relates to a high temperature resistant insulating composition for use in an insulating coating layer of an insulating conductive wire. The high temperature resistant insulating composition comprises an organic polymer and an inorganic binder. The content of the inorganic binder is ranged between 10% and 90% by weight. The high temperature resistant insulating composition has flexibility and toughness at a low temperature between −60° C. to about 200° C., for example the room temperature. After a high temperature treatment between 400° C. and 1000° C. is performed, the residual of the high temperature resistant insulating composition still possesses high strength and insulating property. An example of the organic polymer includes but is not limited to organic silicon resin, polyimide, polyester, polyesterimide, polyamideimide, or a combination thereof. An example of the inorganic binder includes but is not limited to low melting glass powder, low melting glass powder coated ceramic granule/fiber, a mixture of glass and ceramic, a mixture of boric anhydride and aluminum oxide, or a combination thereof.

Before the high temperature treatment is performed, the particles of the inorganic binder are distributed in the organic polymer. The particles of the inorganic binder may be contacted with or separated from each other, but no strong linkage is created between adjacent particles of the inorganic binder. Meanwhile, the flexibility and strength of the high temperature resistant insulating composition is dependent on the properties of the organic polymer. After the high temperature treatment is performed at a predetermined temperature, the property of the organic polymer is somewhat degraded. For example, some organic polymer (e.g. polyvinyl alcohol) is decomposed, oxidized or vaporized. Due to the high temperature treatment, some linkages will be formed between the particles of the inorganic binder and between the inorganic binder and the high temperature residual of the organic polymer.

Moreover, since the volume resistivity of the high temperature residual of the organic polymer is higher than 1MΩmeter, the high temperature resistant insulating composition after the high temperature treatment still possesses sufficient strength and insulating property. In some cases, during the high temperature annealing procedure, the inorganic binder (e.g. low melting glass) will be transformed into liquid state. So, the tiny cracks between the residuals of the organic polymer after the high temperature treatment will be repaired. As a result, after the temperature is reduced, the high temperature resistant insulating composition still possesses strength and insulating property.

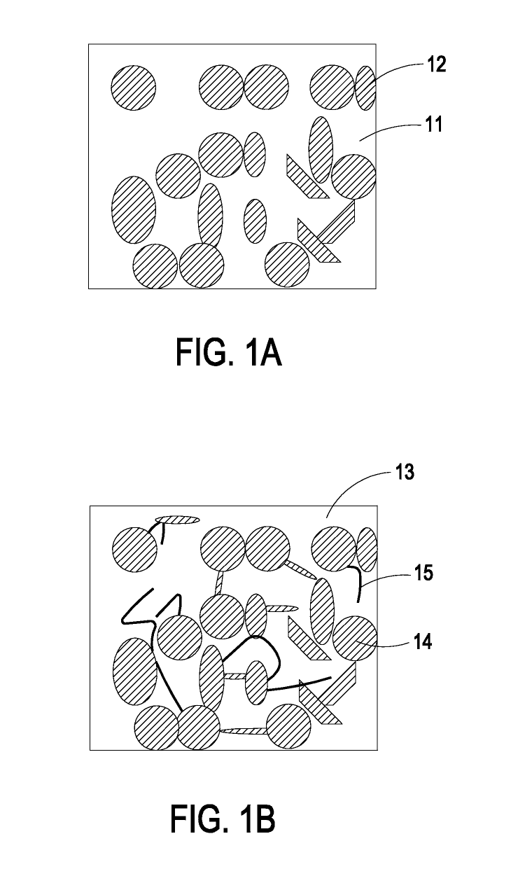

FIG. 1A schematically illustrates the mixture of the inorganic binder and the organic polymer of the high temperature resistant insulating composition before the high temperature treatment. As shown in FIG. 1A, the high temperature resistant insulating composition includes the organic polymer 11 (e.g. organic silicon resin) and the inorganic binder 12 (e.g. low melting glass having a softening/sintering temperature of about 450° C.). At low temperature between −60° C. to about 200° C., the organic polymer 11 contained in the high temperature resistant insulating composition offers flexibility and toughness.

FIG. 1B schematically illustrates the mixture of the inorganic binder and the residual of the organic polymer after the high temperature treatment and a cooling procedure. During the high temperature treatment at a temperature above 400° C., the organic polymer 11 is decomposed or vaporized (e.g. pyrolysis). The residual 13 of the organic polymer 11 (e.g. organic silicon resin) after the high temperature treatment includes siliceous compound such as silicon dioxide (SiO2) or silicon carbide containing oxygen (SiCO). The residual 13 is high temperature resistant and high electrically insulating. Since the texture of the residual 13 is more loosened, the strength is low. On the other hand, the inorganic binder 12 (e.g. low melting glass) is transformed into liquid glass 14 at the high temperature. The liquid glass 14 diffuses into the residual 13. As shown in FIG. 1B, the symbol 15 indicates the liquid glass 14 diffusing into the residual 13. After cooled down to room temperature for example, the liquid glass 14 is transformed into the solid glass and thus the integral structure is retained. In other words, the interaction between the inorganic binder 12 and the interaction between the inorganic binder 12 and the organic polymer residual 13 will result in cross-linked network in order to exhibit sufficient strength and insulating property of the finished product.

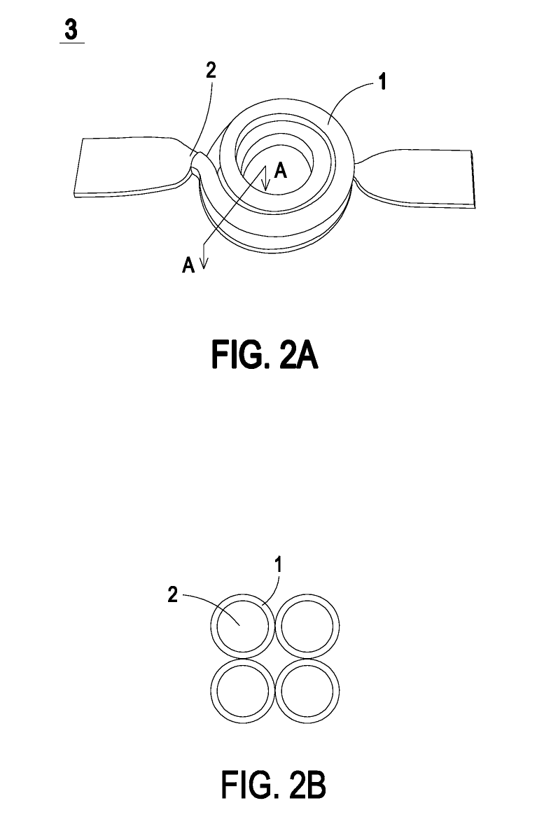

FIG. 2A is a schematic perspective view illustrating a coil made with an insulating wire coated with the high temperature resistant insulating composition of the present invention. FIG. 2B is a schematic cross-sectional view of the insulating wire shown in FIG. 2A. Please refer to FIGS. 2A and 2B. After the high temperature resistant insulating composition of the present invention is coated on the surface of the conductive wire 2, an insulating coating layer 1 is formed on the conductive wire 2 so as to produce the insulating wire 3. The insulating wire 3 could be wound into a coil (also indicated as the numeral 3) or bent into other structure. As mentioned above, the high temperature resistant insulating composition of the present invention has flexibility and toughness at a low temperature between −60° C. to about 200° C.; and the residual of the high temperature resistant insulating composition still possesses high strength and insulating property after a high temperature treatment above 400° C. (e.g. between 400° C. and 1000° C.) is performed. As a consequence, after the coil 3 could be buried in the magnetic powder, the coil 3 and the magnetic powder are compacted and then subject to a high temperature annealing/sintering procedure, thereby producing a magnetic element. By using the high temperature resistant insulating composition of the present invention, the electromagnetic properties of the magnetic element is enhanced and the fabricating process of the magnetic element is simplified and feasible for mass production.

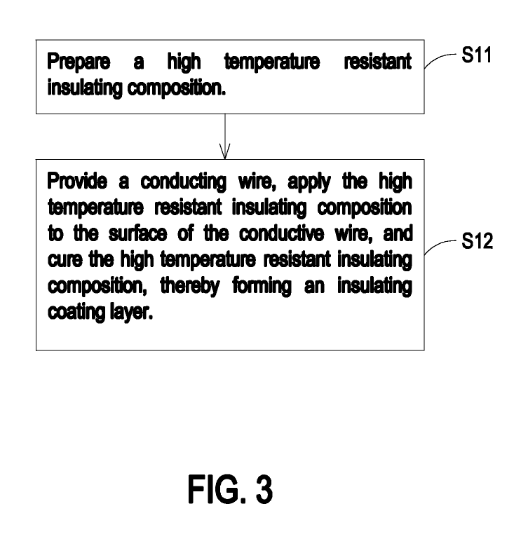

FIG. 3 schematically illustrates a flowchart of a process for fabricating an insulating wire according to the present invention. Hereinafter, the process for fabricating the insulating wire will be illustrated with reference to FIGS. 2A, 2B and 3. First of all, a high temperature resistant insulating composition is prepared (Step S11). The ingredients and the characteristics of the high temperature resistant insulating composition have been illustrated above, and are not redundantly described herein. In an embodiment, the liquid organic polymer and the inorganic binder at a specified ratio are homogeneously mixed. An example of the organic polymer includes but is not limited to organic silicon resin, polyimide, polyester, polyesterimide, polyamideimide, or a combination thereof. An example of the inorganic binder includes but is not limited to low melting glass powder, low melting glass coated ceramic granule/fiber, a mixture of glass and ceramic, a mixture of boric anhydride and aluminum oxide, or a combination thereof. The content of the inorganic binder is ranged between 10% and 90% by weight of the high temperature resistant insulating composition. Next, a conductive wire 2 is provided, the high temperature resistant insulating composition in a liquid state is uniformly coated on the surface of the conductive wire 2, and then the insulating composition is cured (e.g. heat-cured or light-cured) so as to form an insulating coating layer 1 of the desired thickness (Step S12). Meanwhile, the insulating wire 3 is produced. The thickness of the insulating coating layer 1 is ranged from 5 μm to 200 μm. For ease of coating the high temperature resistant insulating composition on the surface of the conductive wire 2, the viscosity of the high temperature resistant insulating composition in the liquid state needs to be elaborately adjusted. For example, the addition of solvent (e.g. toluene, xylene, or the like) could adjust the viscosity of the insulating composition. In some embodiments, the inorganic binder (e.g. low melting inorganic binder) could be directly added to the semi-solid organic polymer (e.g. organic silicon resin) during the process of producing the semi-finished product of the organic polymer, thereby preparing the high temperature resistant insulating composition. Next, the high temperature resistant insulating composition is extruded and applied on the conductive wire 2, and subjected to a secondary curing procedure.

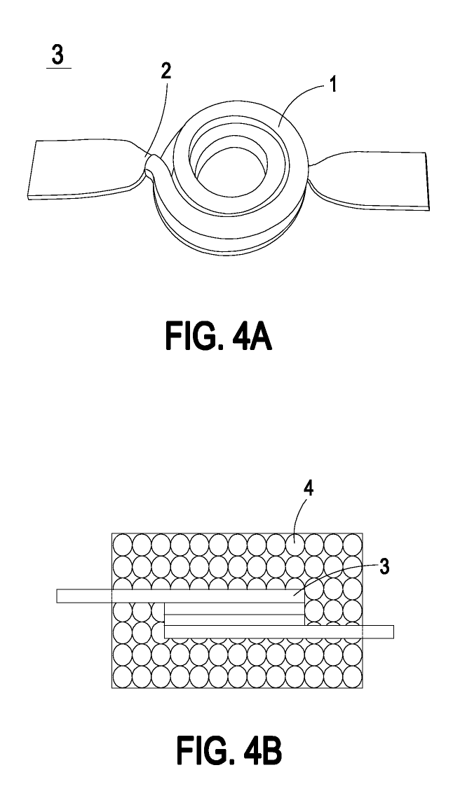

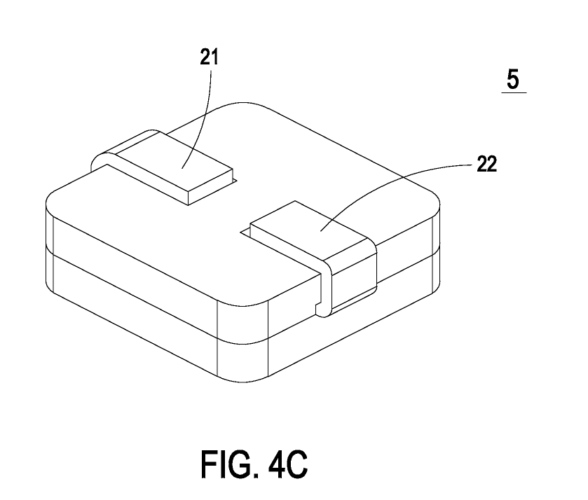

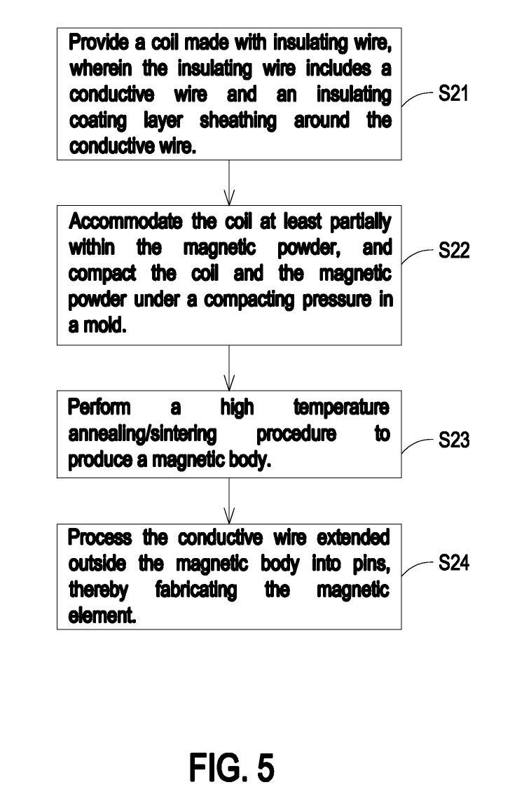

FIGS. 4A, 4B and 4C are schematic views illustrating the steps of fabricating a magnetic element according to the present invention. FIG. 5 schematically illustrates a flowchart of a process for fabricating a magnetic element according to the present invention. Please refer to FIGS. 4A, 4B, 4C and 5. The magnetic element 5 comprises an insulating wire 3 and a magnetic body 4. The insulating wire 3 is wound into a coil, which is accommodated within the magnetic body 4. The insulating wire 3 includes a conductive wire 2 and an insulating coating layer 1 sheathing around the conductive wire 2. The insulating coating layer 1 is produced by coating the high temperature resistant insulating composition onto the surface of the conductive wire 2. The high temperature resistant insulating composition comprises an organic polymer and an inorganic binder. The content of the inorganic binder is ranged between 10% and 90% by weight. The high temperature resistant insulating composition has flexibility and toughness at a low temperature between −60° C. to about 200° C., for example the room temperature. After a high temperature treatment above 400° C. (e.g. between 400° C. and 1000° C.) is performed, the residual of the high temperature resistant insulating composition still possesses high strength and insulating property.

Please refer to FIGS. 4A, 4B, 4C and 5 again. The process for fabricating the magnetic element 5 comprises the following steps. First of all, a coil made with insulating wire 3 is provided (Step S21). The insulating wire 3 includes a conductive wire 2 and an insulating coating layer 1 sheathing around the conductive wire 2. The insulating wire 3 is wound into a coil. The procedure of producing the insulating wire 3 is similar to that shown in the flowchart of FIG. 3, and is not redundantly described herein. Next, the coil 3 is accommodated at least partially within the magnetic material, and the coil 3 and the magnetic powder are compacted under a compacting pressure in a mold (Step S22). An example of the magnetic material includes but is not limited to FeAlSi magnetic powder, FeNi magnetic powder, FeNiMo magnetic powder, FeSi magnetic powder, FeSiCr magnetic powder, ferrite material (FeNiZn magnetic powder or FeMnZn magnetic powder). The compacting pressure is for example 20 ton/cm². Next, after the coil and the magnetic powder are compacted, a high temperature annealing/sintering procedure is performed to produce a magnetic body 4 (Step S23). The high temperature treatment is carried out at a temperature above 400° C., preferably between 400° C. and 1000° C. In some embodiments, the softening/sintering temperature of the inorganic binder of the insulating coating layer 1 is lower than a predetermined temperature (e.g. an annealing/sintering temperature of the magnetic powder core). Afterwards, the conductive wire 2 extended outside the magnetic body 4 is processed into pins 21 and 22. Meanwhile, the resulting structure of the magnetic element 5 is finished. An example of the magnetic element includes but is not limited to an inductor, a transformer, a common mode choke, or a magnetic amplifier.

Hereinafter, the present invention will be described in more detail through the following examples.

### EXAMPLE 1

In this example, an organic silicon resin 0E6630 (commercially available from DowCorning) is selected as the organic polymer, and glass powder (e.g. glass powder used as seal material in ceramic packages) having a softening point of about 450° C. and particle size of about 10 μm is selected as the inorganic binder, wherein the content of the glass powder is ranged between 10% and 90% by weight. After the insulating composition is uniformly coated on a surface of a conductive wire, the insulating composition is baked and cured to form an insulating coating layer. The cured insulating coating layer is sintered at 650° C. for a certain period. The experiment result shows that the sintered product has sufficient strength and possesses insulating property. The volume resistivity is higher than 1MΩmeter. Moreover, if the content of the glass powder is above 40% by weight, the strength is higher than FeAlSi magnetic powder core.

### EXAMPLE 2

In this example, polyimide is selected as the organic polymer, and glass powder having a softening point of about 450° C. and particle size of about 10 μm is selected as the inorganic binder, wherein the content of the glass powder is ranged between 10% and 90% by weight. After the insulating composition is uniformly coated on a surface of a conductive wire, the insulating composition is baked and cured to form an insulating coating layer. The cured insulating coating layer is sintered at 600° C. for a certain period. The experiment result shows that the sintered product has sufficient strength and possesses insulating property. The volume resistivity is higher than 1MΩmeter.

### EXAMPLE 3

In this example, an organic silicon resin 0E6630 (commercially available from DowCorning) is selected as the organic polymer, and glass powder having a softening point of about 450° C. and particle size of about 10 μm is selected as the inorganic binder. In this example, the ratio of the organic polymer to the inorganic binder is 10/10, 10/7, 10/6 and 10/4 in order to formulate different concentration of insulating composition. After each insulating composition is uniformly coated on a surface of a conductive wire (e.g. a copper wire), the insulating composition is baked and cured to form an insulating coating layer having a thickness of about 30 μm. Each insulating wire is wound into a coil and accommodated within the FeAlSi magnetic powder, and compacted under a compacting pressure of 20 ton/cm². A high temperature annealing/sintering procedure at 650° C. is performed to produce a magnetic element (e.g. an inductor). In comparison to the conventional iron powder core inductor having the similar size and inductance, the magnetic element produced in this example has enhanced efficiency (especially light load efficiency) when applied to a point of load (POL) DC-to-DC converter. The testing results demonstrate that each turn of the coil can withstand a voltage value greater than 12V.

If there is a large difference between the thermal expansion coefficient (CTE) of the conductive wire (e.g. a copper wire) and the thermal expansion coefficient (CTE) of the insulating coating layer, some cracks are possibly generated on the insulating coating layer during the cooling procedure after the high temperature annealing/sintering procedure. For avoiding such problems, the contents and types of the organic polymer and the inorganic binder should be elaborated selected or adjusted in order to adjust the thermal expansion coefficient (CTE) of the insulating coating layer to be ranged between the conductive wire (e.g. a copper wire) and the magnetic material (e.g. 5˜17 10⁻⁶). Alternatively, by selecting a low melting or softening glass, the softening/sintering point of the inorganic binder could be reduced to about 300° C.

Since the magnetic element (e.g. an inductor) could withstand a voltage value greater than 12V, the micro cracks of the magnetic element are acceptable because air is sufficient to provide isolative effect. On the other hand, for withstanding a relatively higher voltage (e.g. 600V), the problems of causing cracks on the insulating coating layer need to be solved. In some embodiments, the voltage between adjacent turns of coil could be reduced by changing the winding mechanism.

During the coil and the magnetic powder are compacted in the process of fabricating the magnetic element, the semi-finished product is possibly broken because the coil and the magnetic powder core has different coefficient of elastic recovery. The addition of some organic binder into the magnetic powder core could solve this problem.

During the process of fabricating the magnetic element, the magnetic powder is possibly filled between adjacent turns of the coil, and thus the inductance of the magnetic element is reduced. For solving this problem, the coil could be immersed into the high temperature resistant insulating composition and then cured. As such, the gaps between adjacent turns of the coil are completely sealed and the magnetic powder fails to penetrate into the gaps.

In a case that the magnetic element is subject to the annealing/sintering process in a reduced atmosphere, the conductive wire 2 (e.g. a copper wire) becomes brittle because the oxygen content of the conductive wire 2 is too high. For example, when a reduced gas (e.g. hydrogen gas) reacts with cuprous oxide dissolved in copper, water vapor are generated. If the pressure of the water vapor is too high, some cracks are possibly generated on the conductive wire, and thus the strength and the conductivity of the conductive wire is deteriorated. For solving this problem, the oxygen content of the copper wire is preferably lower than 200 ppm. When conductive wire is made of other metallic material, the oxygen content should also be taken into consideration.

From the above description, the high temperature resistant insulating composition of the present invention comprises an organic polymer and an inorganic binder. The high temperature resistant insulating composition has flexibility and toughness at a low temperature. After a high temperature treatment, the high temperature residual of the organic polymer still has sufficient strength and insulating property. The high temperature resistant insulating composition of the present invention is suitable for fabricating a high-performance winding embedded magnetic element. When the high temperature resistant insulating composition is coated on a surface of the conductive wire, an insulating wire is formed. With the insulating wire, a coil can be made. Since the coil could be directly buried within the magnetic powder core that withstands high temperature annealing/sintering procedure, the electromagnetic properties of the magnetic element are enhanced. In addition, the process for fabricating magnetic elements according to the present invention has increased throughput, and is suitable for mass production. Since the magnetic element has increased space utilization, the magnetic element of the present invention can be applied to high power density electronic product.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A high temperature resistant insulating composition comprising:
an organic polymer; and
an inorganic binder ranged between 10% and 90% by weight of said high temperature resistant insulating composition,
wherein said high temperature resistant insulating composition still possesses strength and insulating property after a high temperature treatment.

2. The high temperature resistant insulating composition according to claim 1 wherein a high temperature residual of the organic polymer after said high temperature treatment has a volume resistivity higher than 1MΩmeter.

3. The high temperature resistant insulating composition according to claim 1 wherein said organic polymer is completely vaporized after said high temperature treatment at a predetermined temperature.

4. The high temperature resistant insulating composition according to claim 1 wherein said organic polymer includes organic silicon resin, polyimide, polyester, polyesterimide, polyamideimide, or a combination thereof.

5. The high temperature resistant insulating composition according to claim 1 wherein said inorganic binder is an inorganic sintered binder.

6. The high temperature resistant insulating composition according to claim 1 wherein said inorganic binder includes low melting glass powder, low melting glass coated ceramic granule/fiber, a mixture of glass and ceramic, a mixture of boric anhydride and aluminum oxide, or a combination thereof.

7. The high temperature resistant insulating composition according to claim 1 wherein the softening/sintering temperature of said inorganic binder is lower than a predetermined temperature.

8. The high temperature resistant insulating composition according to claim 1 wherein said organic polymer is organic silicon resin and said inorganic binder is a low melting glass powder.

9. The high temperature resistant insulating composition according to claim 1 wherein said temperature resistant insulating composition has flexibility and toughness at a low temperature between −60° C. to about 200° C.

10. The high temperature resistant insulating composition according to claim 1 wherein said high temperature resistant insulating composition after said high temperature treatment between 400° C. and 1000° C. still possesses strength and insulating property.

11. An insulating wire comprising:
a conductive wire; and
an insulating coating layer sheathing around said conductive wire and made of a high temperature resistant insulating composition, wherein said high temperature resistant insulating composition comprises an organic polymer and an inorganic binder ranged between 10% and 90% by weight of said high temperature resistant insulating composition, and said high temperature resistant insulating composition after a high temperature treatment still possesses strength and insulating property.

12. The insulating wire according to claim 11 wherein said insulating coating layer has a thickness ranged from 5 μm to 200 μm.

13. The insulating wire according to claim 11 wherein said conductive wire is wound into a coil and accommodated at least partially within a magnetic material, said magnetic material is compacted and subject to a high temperature treatment at a temperature above 400° C. to produce a magnetic body, and said coil and said magnetic body are collectively formed into a magnetic element.

14. The insulating wire according to claim 13 wherein said magnetic material is FeAlSi magnetic powder, FeNi magnetic powder, FeNiMo magnetic powder, FeSi magnetic powder, FeSiCr magnetic powder, or ferrite material.

15. The insulating wire according to claim 13 wherein said insulating coating layer has a thermal expansion coefficient ranged between said conductive wire and said magnetic material.

16. The insulating wire according to claim 13 wherein the softening/sintering point of said inorganic binder is lower than the annealing/sintering temperature of said magnetic material.

17. The insulating wire according to claim 11 wherein the oxygen content of the conductive wire is lower than 200 ppm.

18. A magnetic element comprising:
a magnetic body; and
an insulating wire is wound into a coil and at least partially accommodated within said magnetic body, and comprising a conductive wire and an insulating coating layer, wherein said insulating coating layer is sheathed around said conductive wire and made of a high temperature resistant insulating composition, said high temperature resistant insulating composition comprises an organic polymer and an inorganic binder ranged between 10% and 90% by weight of said high temperature resistant insulating composition, and said high temperature resistant insulating composition after a high temperature treatment still possesses strength and insulating property

19. The magnetic element according to claim 18 wherein said magnetic body is made of a magnetic material, and said magnetic material is compacted and subject to a high temperature treatment at a temperature above 400° C. to produce said magnetic body.

20. The magnetic element according to claim 19 wherein said magnetic material is FeAlSi magnetic powder, FeNi magnetic powder, FeNiMo magnetic powder, FeSi magnetic powder, FeSiCr magnetic powder, or ferrite material, said inorganic binder includes low melting glass powder, lower melting glass coated ceramic granule/fiber, a mixture of glass and ceramic, a mixture of boric anhydride and aluminum oxide, or a combination thereof, and said organic polymer includes organic silicon resin, polyimide, polyester, polyesterimide, polyamideimide, or a combination thereof.
